(19) United States
(12) Patent Application Publication
(10) Pub. No.: US 2022/0193948 A1
(43) Pub. Date: Jun. 23, 2022

(54) MOBILE INDUSTRIAL MIXING APPARATUS

(71) Applicant: One Pass Innovators, LLC, Zeeland, MI (US)

(72) Inventors: Ryan DeWind, Zeeland, MI (US); Gregory Allen DeWind, Zeeland, MI (US)

(21) Appl. No.: 17/558,486

(22) Filed: Dec. 21, 2021

Related U.S. Application Data
(60) Provisional application No. 63/128,631, filed on Dec. 21, 2020.

(51) Int. Cl. B28C 5/14; B28C 5/42; B28C 5/08

(52) U.S. Cl. CPC B28C 5/148; B28C 5/4244; B28C 5/085; B28C 5/0893; B28C 5/4237; B28C 5/0818

(57) ABSTRACT

A mobile industrial mixing apparatus includes a frame, a mixing chamber, a motor, a storage bin, and a transport mechanism. The mixing chamber is coupled to the frame and includes a housing, a top end, and a bottom end, and includes a mixing mechanism disposed within the mixing chamber, the mixing mechanism mixing an industrial powdered bulk material with a liquid. A discharge opening allows a mixture of the industrial powdered bulk material and the liquid to leave the mixing chamber. The motor is coupled to the mixing mechanism and drives the mixing mechanism. The storage bin is coupled to the frame and is disposed proximate to the bottom end of the mixing chamber, the storage bin receiving the mixture of the industrial powdered bulk material and the liquid. The transport mechanism is coupled to the frame and transports the mixing chamber and the storage bin.

### CROSS-REFERENCE TO RELATED APPLICATION

This application claims priority from U.S. Provisional Patent Application Ser. No. 63/128,631 filed on Dec. 21, 2020, entitled “MOBILE INDUSTRIAL MIXING APPARATUS”, the entire disclosure of which is hereby incorporated by reference in its entirety.

### BACKGROUND OF THE DISCLOSURE

### 1. Field of the Disclosure

The disclosure relates in general to industrial mixing, and more particularly, to a mobile industrial mixing apparatus.

### 2. Background Art

Large quantities of bulk powdered material, such as cement or Bentonite, are used in many industrial applications. In many of these industrial applications, this bulk material must be combined with a liquid, such as water, to maintain a desired proportion between the two materials. Typically, such mixing utilizes a stationary industrial mixing apparatus that mixes relatively small batches of a mixture of the bulk powdered material and the liquid. Once a batch of mixture is used up, work is delayed while another batch of the mixture is prepared. These delays significantly impact workflow on a worksite. One such application of such a stationary industrial mixing apparatus is for an industrial trencher.

### SUMMARY OF THE DISCLOSURE

The disclosure is directed to a mobile industrial mixing apparatus that includes a frame, a mixing chamber, a motor, a storage bin, and a transport mechanism. The mixing chamber is coupled to the frame and includes a housing, a top end, and a bottom end. The mixing chamber includes a mixing mechanism disposed within the mixing chamber, the mixing mechanism mixing an industrial powdered bulk material with a liquid. The mixing chamber further including a discharge opening to allow a mixture of the industrial powdered bulk material and the liquid to leave the mixing chamber. The motor is coupled to the mixing mechanism and drives the mixing mechanism. The storage bin is coupled to the frame and is disposed proximate to the bottom end of the mixing chamber, the storage bin receiving the mixture of the industrial powdered bulk material and the liquid. The transport mechanism is coupled to the frame and transports the mixing chamber and the storage bin.

In some configurations, the industrial powdered bulk material is Bentonite and the liquid is water.

In some configurations, the mixing mechanism is a first mixing mechanism and the mixing chamber is a first mixing chamber, the mobile industrial mixing apparatus further comprising a second mixing mechanism disposed within a second mixing chamber, and a divider to separate the first mixing chamber from the second mixing chamber.

In some configurations, the mixing mechanism includes a rotating shaft that extends from a front of the mixing chamber to a back of the mixing chamber.

In some configurations, the mixing mechanism further includes arms disposed along a length of the rotating shaft, with paddles disposed on ends of the arms, respectively.

In some configurations, the rotating shaft is a first rotating shaft, the mixing mechanism includes a second rotating shaft.

In some configurations, the motor is one of a hydraulic motor, an electric motor, pneumatic motor, gasoline motor, and propane motor, to drive the mixing mechanism.

In some configurations, the discharge opening is a first discharge opening, the storage bin being tapered to funnel the mixture of the industrial powdered bulk material and the liquid to a second discharge opening of the storage bin.

In some configurations, the transport mechanism includes one of wheels and a continuous track.

In some configurations, the mobile industrial mixing apparatus further includes a liquid storage tank, coupled to the frame, to store the liquid during transport of the industrial powdered bulk material, the transport mechanism further transporting the liquid storage tank.

In some configurations, the industrial mixing apparatus further includes a front side and a back side, the liquid storage tank being disposed on the front side of the mobile industrial mixing apparatus.

In some configurations, the mobile industrial mixing apparatus further includes a liquid pump, coupled to the frame, to pump the liquid from the liquid storage tank to the mixing chamber.

In some configurations, a system includes an excavator to receive the mixture of the industrial powdered bulk material and the liquid produced by the mobile industrial mixing.

In some configurations, the excavator is an industrial trencher.

In some configurations, the mobile industrial mixing apparatus further includes a hinged door coupled to the housing, the hinged door providing access to the mixing mechanism disposed within the mixing chamber.

In some configurations, the motor is coupled to the mixing mechanism via a belt.

In some configurations, the mobile industrial mixing apparatus further includes a mixture pump to pump the mixture of the industrial powdered bulk material and the liquid away from the mobile industrial mixing apparatus.

In some configurations, a plurality of spray nozzles are disposed within the mixing chamber to spray the liquid onto the industrial powdered bulk material during mixing of the industrial powdered bulk material and the liquid.

### BRIEF DESCRIPTION OF THE DRAWINGS

The disclosure will now be described with reference to the drawings wherein:

FIG. 1 illustrates a front view of an example mobile industrial mixing apparatus, in accordance with at least one embodiment disclosed herein;

FIG. 2 illustrates an isometric view of another example mobile industrial mixing apparatus, in accordance with at least one embodiment disclosed herein;

FIG. 3 illustrates another isometric view of the mobile industrial mixing apparatus shown in FIG. 2, in accordance with at least one embodiment disclosed herein;

FIG. 4 illustrates yet another isometric view of the mobile industrial mixing apparatus shown in FIG. 2, in accordance with at least one embodiment disclosed herein;

FIG. 5 illustrates even yet another isometric view of the mobile industrial mixing apparatus shown in FIG. 2, in accordance with at least one embodiment disclosed herein;

FIG. 6 illustrates one more isometric view of the mobile industrial mixing apparatus shown in FIG. 2, in accordance with at least one embodiment disclosed herein;

FIG. 7 illustrates even one more isometric view of the mobile industrial mixing apparatus shown in FIG. 2, in accordance with at least one embodiment disclosed herein;

FIG. 8 illustrates an example inside view of a storage bin of the mobile industrial mixing apparatus shown in FIGS. 1 and 2, in accordance with at least one embodiment disclosed herein;

FIG. 9 illustrates another example mixing mechanism, in accordance with at least one embodiment disclosed herein;

FIG. 10 illustrates another example mixing mechanism, in accordance with at least one embodiment disclosed herein;

FIG. 11 illustrates another view of the mixing mechanism shown in FIG. 10, in accordance with at least one embodiment disclosed herein; and

FIG. 12 illustrates a system including an example excavator for use with the mobile industrial mixing apparatus shown in FIGS. 1 and 2, in accordance with at least one embodiment disclosed herein.

### DETAILED DESCRIPTION OF THE DISCLOSURE

While this disclosure is susceptible of embodiment(s) in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

It has become appreciated that typical mixing apparatus that are used for mixing bulk powdered material, such as cement or Bentonite, have one or more deficiencies. Such a bulk powdered material is typically mixed with a liquid, such as water, before being used on a worksite. This mixture is typically used throughout the worksite, which typically results in the typical metering apparatus having to be repeatedly moved from one location to another location on the worksite as work progresses. This repeated moving slows work down on the worksite. Additionally, as discussed above typical stationary mixing apparatus make relatively small batches of mixture which requires a worksite to delay work while another batch is prepared. The disclosed embodiment(s) at least mitigate such deficiencies.

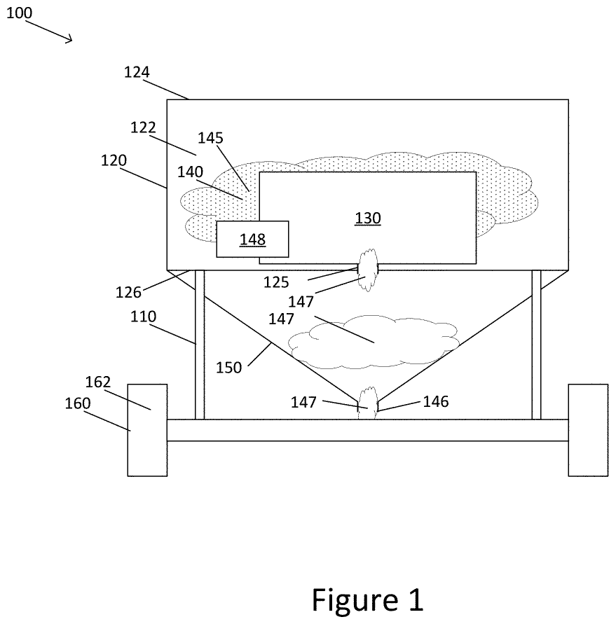

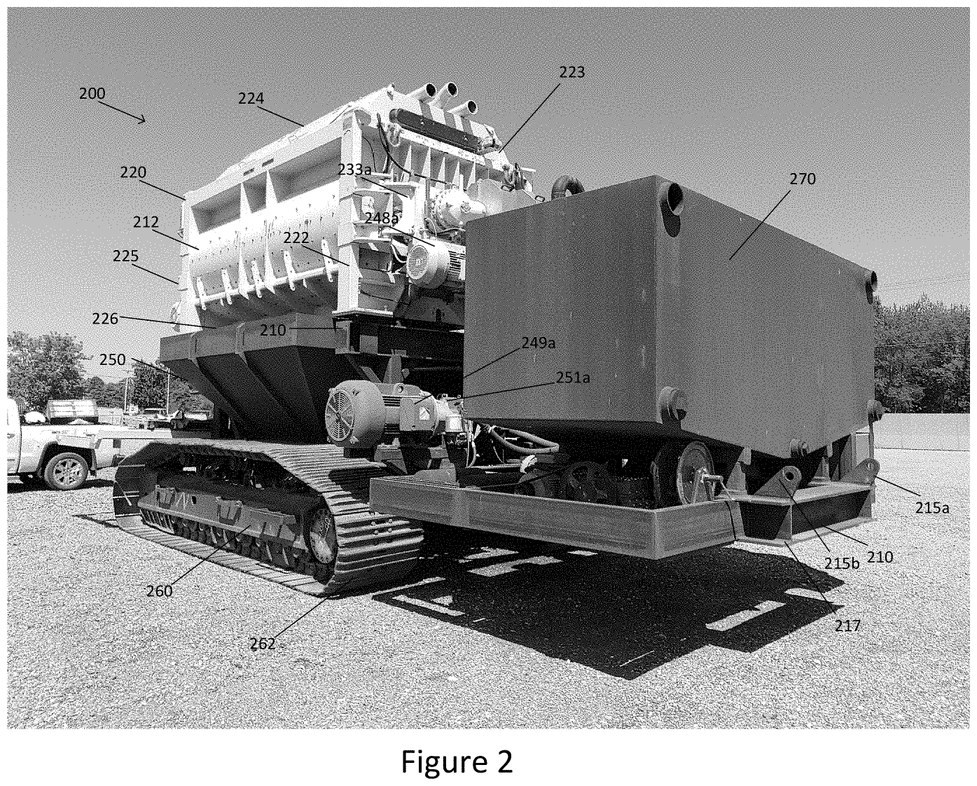

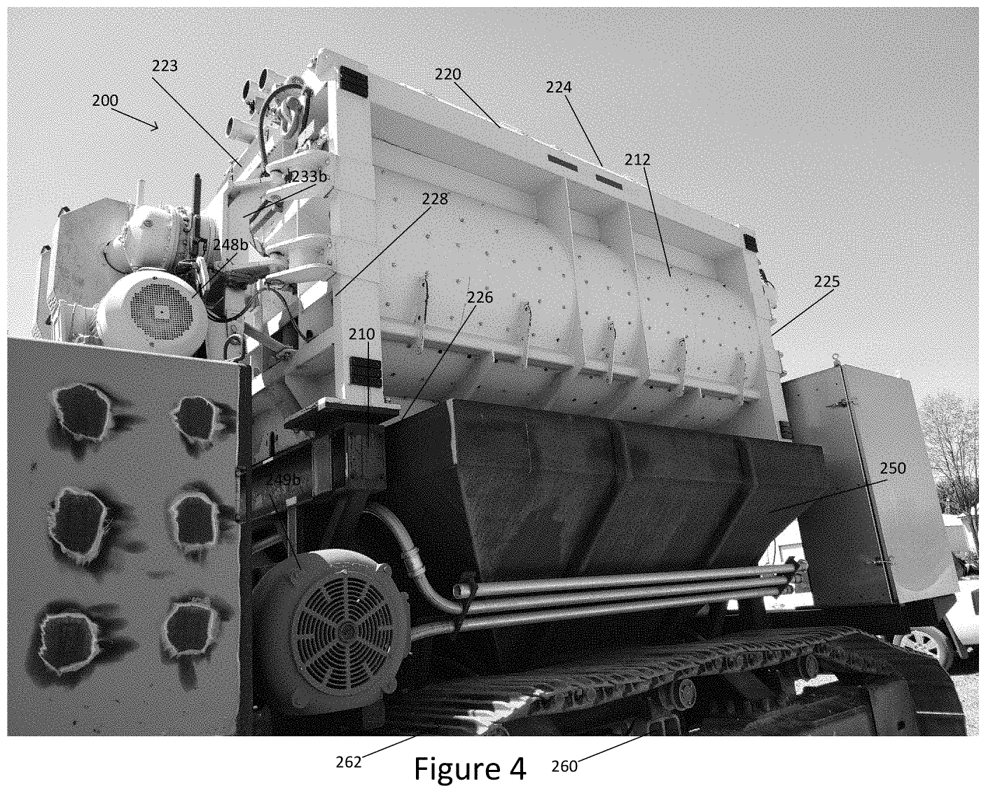

Referring now to the drawings and in particular to FIG. 1, an apparatus is disclosed, such as an example mobile industrial mixing apparatus 100, is shown. Another example mobile industrial mixing apparatus 200 is shown in FIGS. 2-7. The mobile industrial mixing apparatus 100/200 includes a frame 110/210. The frame 110/210 includes a plurality of frame members to which various other components of the mobile industrial mixing apparatus 100/200 are coupled to, as shown. As shown, the frame 110 can be made from boxed members, “I” beam members, or any other shaped members that add strength to the frame 110/210. In at least one embodiment, the frame 210 can be disposed at a front end 222 and a back end 228 of a mixing chamber 220, as shown. In at least one embodiment, one or more couplers, such as couplers 215a/215b disposed on a front 217 of the mobile industrial mixing apparatus 100/200, can be fixed to the frame 110. The couplers 215a/215b allow the mobile industrial mixing apparatus 100/200 to be coupled to another industrial apparatus, such as an excavator, so that the mobile industrial mixing apparatus 100/200 can be moved (e.g., pulled) about a worksite. The mobile industrial mixing apparatus 100 can be made from steel, aluminum, or any other material that has a strength needed to support the components of the mobile industrial mixing apparatus 100/200.

The mobile industrial mixing apparatus 100/200 further includes the mixing chamber 120/220. The mixing chamber 120/220 is coupled to the frame 110/210 and includes a housing 112/212, a top end 124/224, and a bottom end 126/226. The mixing chamber 120/220 includes a mixing mechanism 130 disposed within the mixing chamber 120/220 and to mix an industrial powdered bulk material 140 with a liquid 145, such as water. The mixing mechanism 130 can be a shear mixing mechanism, a diffusive mixing mechanism, a convective mixing mechanism, a combination of at least two of these types of mixing mechanism, or any other type of mixing mechanism that provide for mixing of the industrial powdered bulk material 140 with the liquid 145. The mixing chamber 120/220 further includes a discharge opening 125 to allow a mixture 147 of the industrial powdered bulk material 140 and the liquid 145 to leave the mixing chamber 120/220.

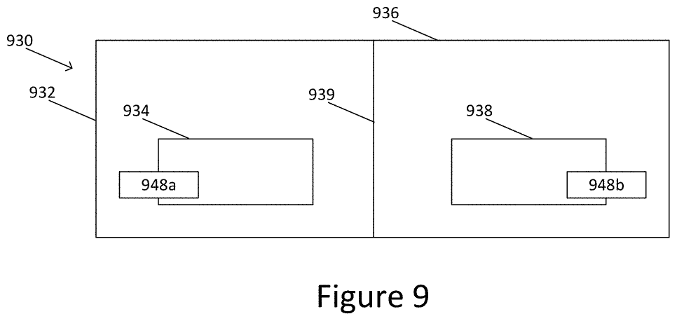

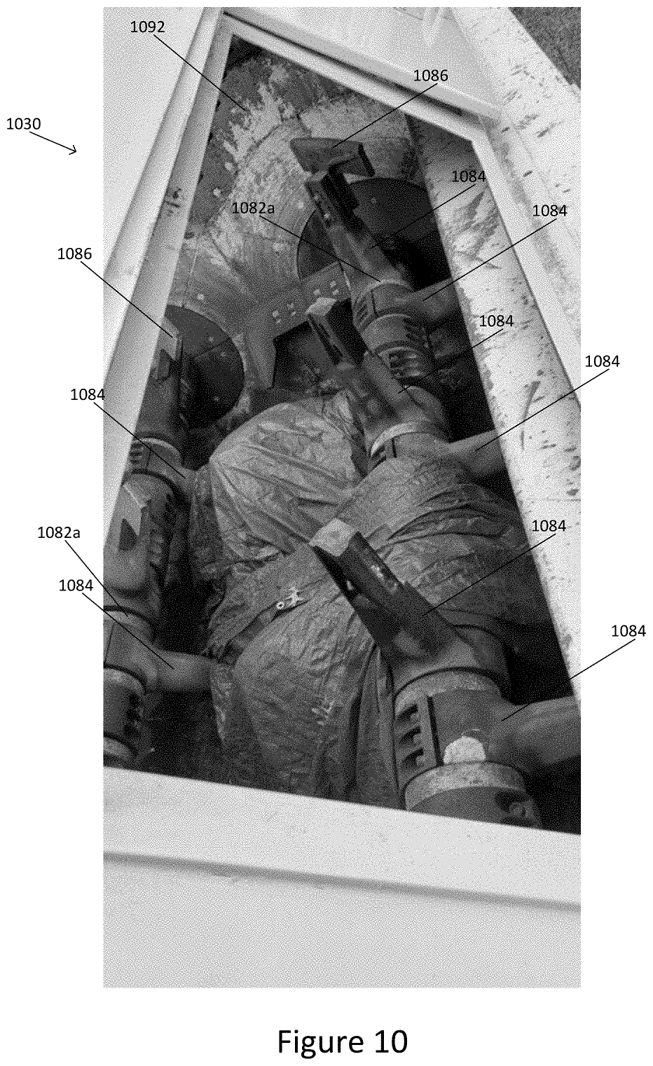

In at least one embodiment, as shown in FIG. 9 the mixing mechanism 130 can be a mixing mechanism 930 that includes a first mixing mechanism 934 disposed within a first mixing chamber 932 and a second mixing mechanism 938 disposed within a second mixing chamber 936. The mixing chamber 930 further includes a divider 939 to separate the first mixing chamber 932 from the second mixing chamber 936. In at least one embodiment, as shown in FIG. 10 the mixing mechanism 130 or the mixing mechanisms 934/938 can each include at least two rotating shafts, such as a first rotating shaft 1082a and a second rotating shaft 1082b, onto which arms 1084 are attached to the first and second rotating shafts 1082a/1082b, respectively. Onto free ends of the arms 1084 are disposed paddles 1086 to increase a surface area that is being mixed.

Dividing the mixing chamber 930 into first and second mixing chambers 932/936 allows for mixing of smaller batches of the mixture 147, which is easier to mix than one larger batch, and/or allows for staggering of batches. For example, when the mixture 147 has a finite time of use requirement once prepared, one batch of the mixture 147 can first be prepared within the first mixing chamber 932. Then, as this first batch of the mixture 147 is being used up on the worksite, another batch of the mixture 147 can be prepared in the second mixing chamber 936. This staggered preparation of the mixture 147 between the first and second mixing chambers 932/936 mitigates wasted mixture 147 that may occur if one larger batch cannot be used within the finite time of use requirement once prepared.

As shown in FIGS. 2-7, the mobile industrial mixing apparatus 200 is shown as including the mixing chamber 930. At least one motor, such as one of motors 148/948a/948b (e.g., a hydraulic motor, an electric motor, pneumatic motor, gasoline motor, propane motor, or any other type of motor that is capable of driving the mixing mechanisms 120/932/938), is/are coupled to the mixing mechanisms 120/932/938 and is/are used to drive the mixing mechanisms 120/932/938. In an embodiment where the motors 148/948a/948b are hydraulic motors, the mobile industrial mixing apparatus 200 further includes electric motors 249a/249b disposed between the storage bin 250 and the liquid storage tank 270, on opposite sides of the mobile industrial mixing apparatus 200, as shown. The electric motors 249a/249b are coupled to and drive hydraulic pumps 251a/251b, respectively. In at least one embodiment, each of the mixing mechanisms 120/932/938 can be drive by an associated motor 148/948a/948b, respectively.

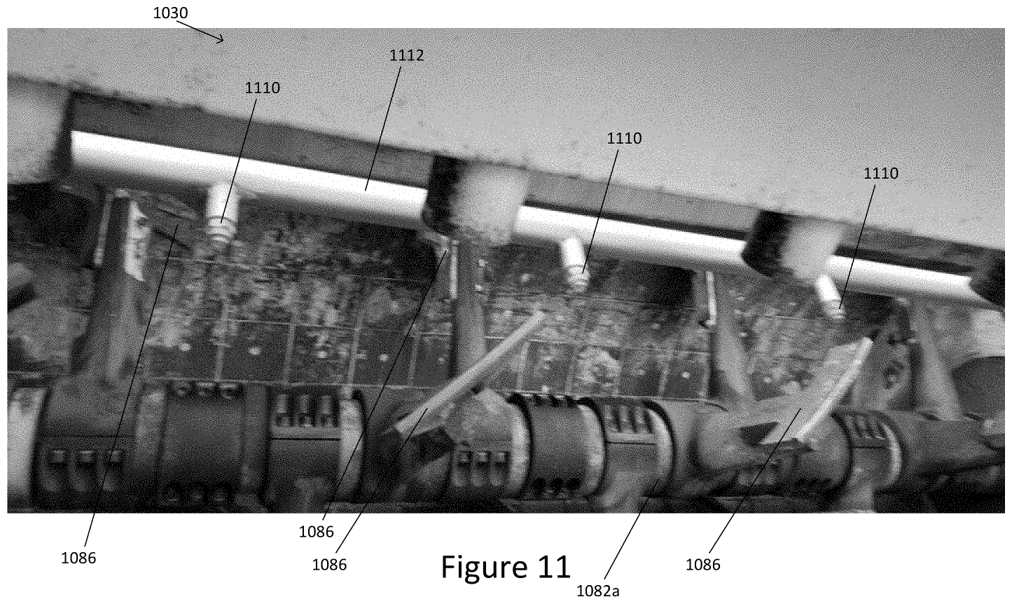

In at least one embodiment, to add the liquid 145 to the mixing chamber 220, the mobile industrial mixing apparatus 200 can further include a plurality of spray nozzles 1110 (FIG. 11) disposed within the mixing chamber 220, the plurality of spray nozzles 1110 coupled to a common pipe 1112. The plurality of spray nozzles 1110 spray the liquid 145 onto the industrial powdered bulk material 140 during mixing of the industrial powdered bulk material 145 and the liquid 145.

In the example of the mobile industrial mixing apparatus 200, four motors 248a/248b/248c/248d are used to drive a mixing mechanism 1030 within the mixing chamber mixing chamber 220, as shown in FIGS. 10 and 11. This mixing mechanism 1030 is viewed through an access panel 1092 disposed at a top of the mixing chamber 220, this access panel 1092 can also be used to add the industrial powdered bulk material 140 to the mixing mechanism 1030. As shown, two of the motors 248a/248b/248c/248d are disposed at each end of the mixing chamber mixing chamber 220, such as proximate to corners of the mixing chamber mixing chamber 220, as shown.

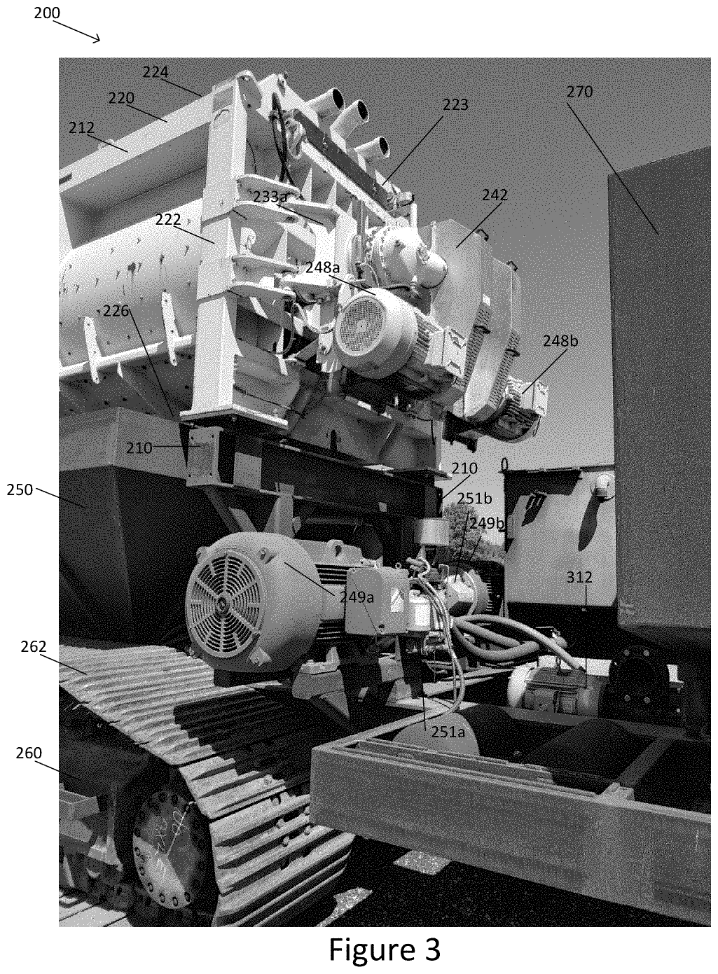

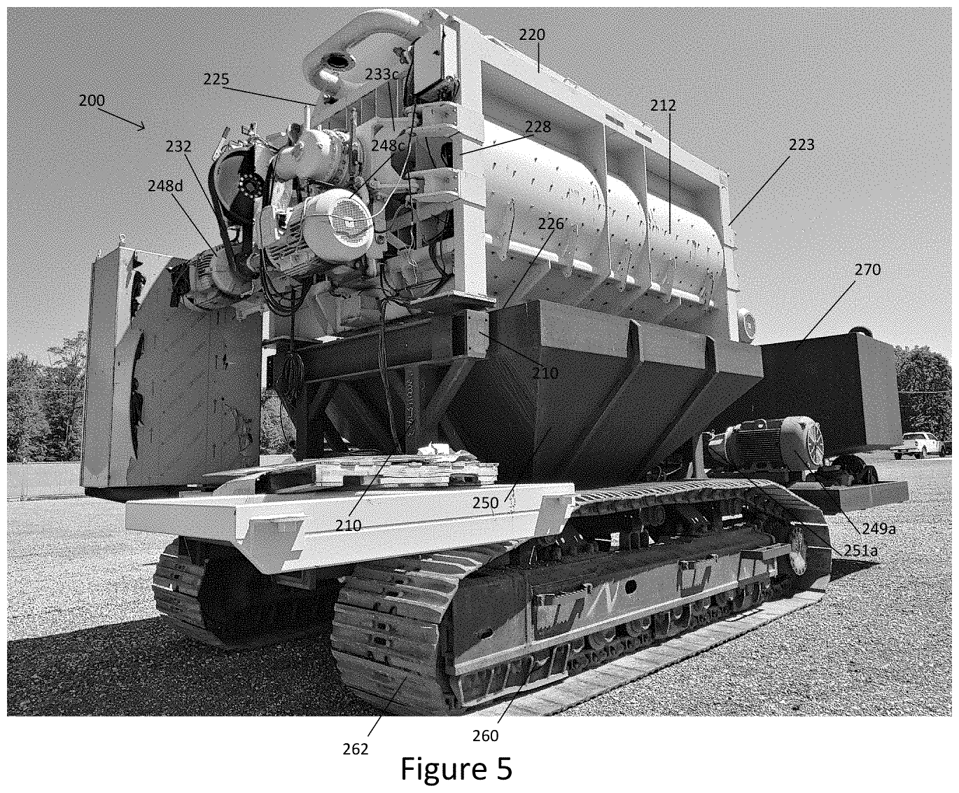

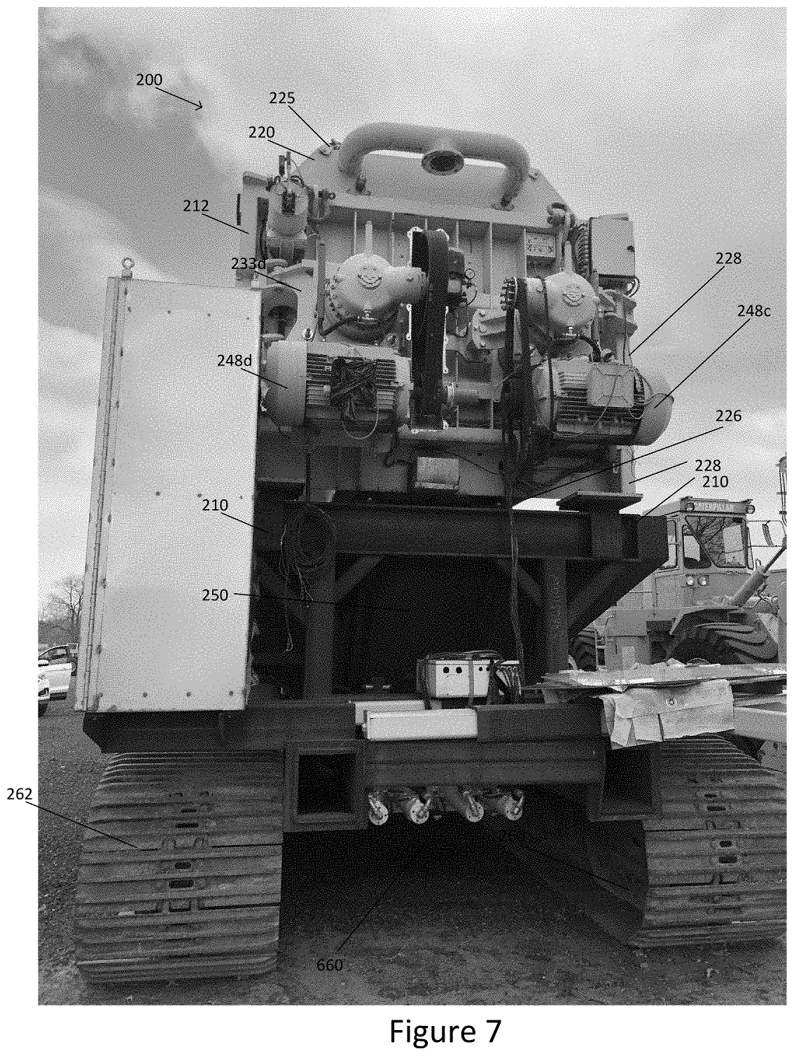

In at least one embodiment, the motors 248a/248b/248c/248d can be coupled to the housing 212 of the mixing chamber 220. The motors 248a/248b/248c/248d are coupled to the mixing mechanism via at least one belt 232, as shown in FIGS. 5 and 7 with protective cover 242 (FIG. 3) removed to expose the belt 232. In at least one embodiment, the mobile industrial mixing apparatus 200 further includes at least one hinged door coupled to the housing 212, such as four hinged doors 233a/233b/233c/233d coupled to the housing 212, as shown. The four motors 248a/248b/248c/248d can be coupled to the four hinged doors 233a/233b/233c/233d, respectively, as shown. The four hinged doors 233a/233b/233c/233d provide access to the mixing mechanism 130 disposed behind the four hinged doors 233a/233b/233c/233d, within the mixing chamber 220.

The mobile industrial mixing apparatus 100/200 further includes a storage bin 150/250. The storage bin 150/250 is also coupled to the frame 110 and is disposed proximate to the bottom end 126/226 of the mixing chamber 150/250. The storage bin 150/250 receives the mixture 147 of the industrial powdered bulk material 140 and the liquid 145. The storage bin 250 can be funnel shaped to direct the mixture 147 toward a center of the storage bin 250, and can include braces disposed along an outside surface of the storage bin 250 to add rigidity to the storage bin 250. The discharge opening 125 is a first discharge opening, the storage bin 150 including a second discharge opening 146.

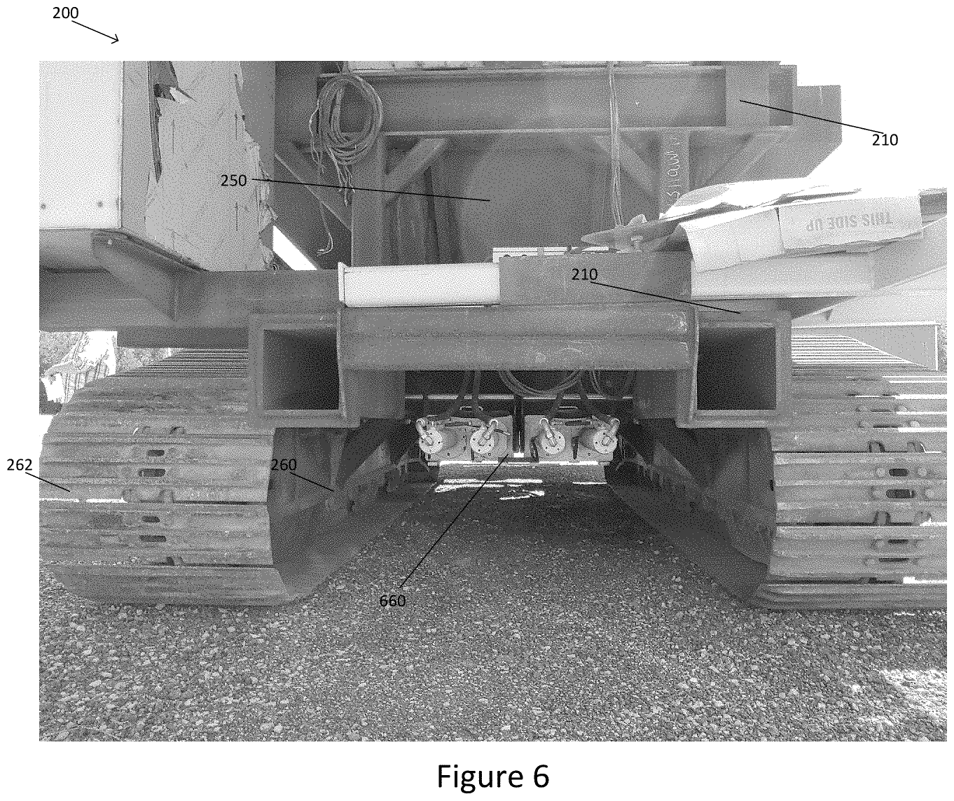

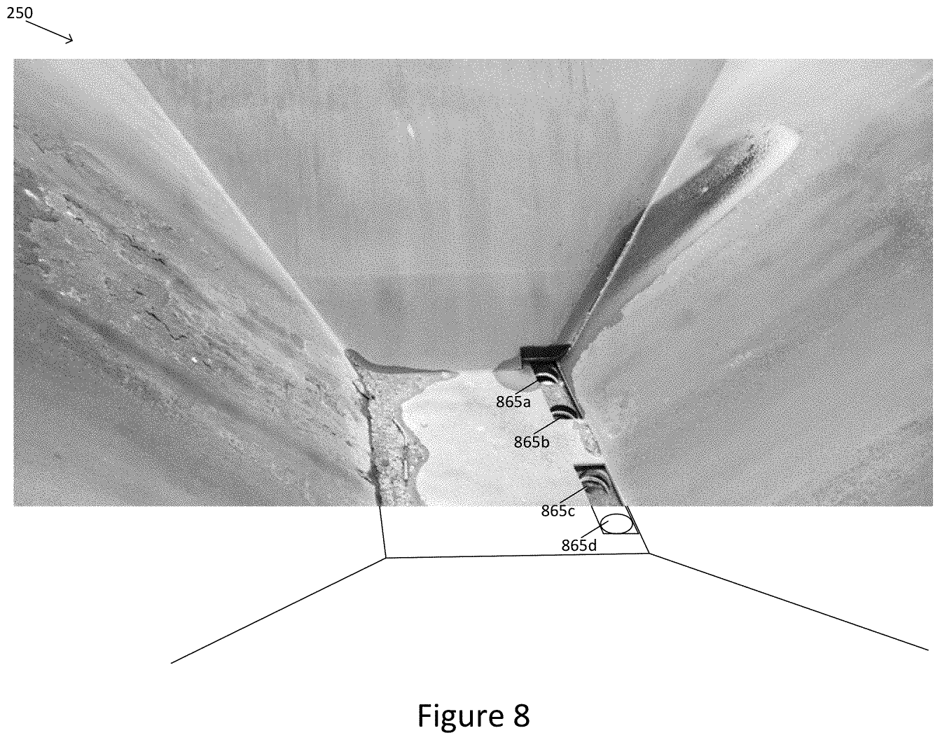

In at least one embodiment, the storage bin 150/250 is tapered to funnel the mixture 147 of the industrial powdered bulk material 140 and the liquid 145 to a plurality of second discharge openings, such as four discharge openings 865a/865b/865c/865d (FIG. 8) disposed along one side of the bottom of the storage bin 250. Such a plurality of discharge openings allows a greater volume of the mixture 147 of the industrial powdered bulk material 140 and the liquid 145 to be removed from the storage bin 250. A mixture pump 660 (FIGS. 6 and 7), coupled to the four discharge openings 865a/865b/865c/865d, such as via pipes (not shown) or hoses (not shown), pumps the mixture 147 of the industrial powdered bulk material 140 and the liquid 145 away from the mobile industrial mixing apparatus 100/200.

The mobile industrial mixing apparatus 100/200 further includes a transport mechanism 160/260 coupled to the frame 110/210. The transport mechanism 160/260 transports the mixing chamber 120/220 and the storage bin 150/250. The transport mechanism 160 can include wheels 162, a continuous track 262, or any other type of transport mechanism that provide mobility to the mixing chamber 120/220 and the storage bin 150/250, and mobility to any other components of the mobile industrial mixing apparatus 100/200, such as those disclosed herein. In at least one embodiment, a motor (not shown) and/or an engine (not shown) can be coupled to the transport mechanism 160/260 such that the mobile industrial mixing apparatus 100/200 can be driven about a worksite like a typical excavator via operator controls (not shown).

In an application where access to the liquid 145 (e.g., water) on a worksite may be limited, it may be convenient to have the liquid 145 local to the mixing mechanism 130/230. In such an application, the mobile industrial mixing apparatus 100/200 can further include a liquid storage tank 270 (FIGS. 2, 3 and 5) to store the liquid 145 during transport of the industrial powdered bulk material 140. The transport mechanism 160/260 further transports the liquid storage tank 270, with the liquid storage tank 270 being coupled to the frame 110/210. In at least one embodiment, the mobile industrial mixing apparatus 100/200 includes a front side 223, and a back side 225, with the liquid storage tank 270 being disposed on the front side 223 of the mobile industrial mixing apparatus 100/200. The designation front side 223/back side 225 is arbitrary, and can be used interchangeably herein, meant only for simplicity of explanation. In at least one embodiment, the mobile industrial mixing apparatus 100/200 further includes a liquid pump 312 (FIG. 3) coupled to the frame 210. The liquid pump 312 pumps the liquid 145 from the liquid storage tank 270 to the mixing chamber 220.

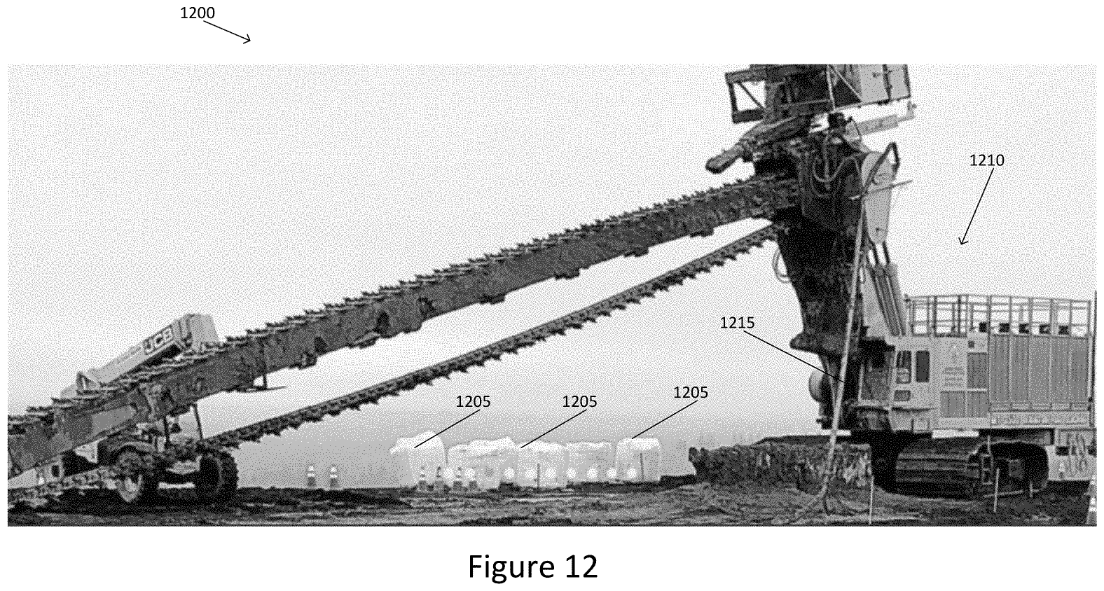

FIG. 12 illustrates a system 1200 including an excavator, such as an industrial trencher 1210. Also shown within the system 1200 are bags 1205 of the industrial powdered bulk material 140 that will later be added to the mixing chamber 220. As shown, a flexible pipe 1215 can be used to carry the mixture 147 of the industrial powdered bulk material 140 and the liquid 145 from the mobile industrial mixing apparatus 100/200 to the trencher 1210. The trencher 1210 can be of the type used for installing a groundwater barrier or a soil Bentonite cutoff wall. This type of barrier prevents groundwater from being able to flow past a location in which the barrier has been installed.

The trencher 1210 can be of the type developed by DeWind Corporation. The trencher 1210 can be of the type that uses one-pass trenching technology, such as model MT2000 or MT3500. These trenchers install various types of systems deeper, faster, safer, and at less cost than most conventional alternatives. The MT 3500 (e.g., with up to 3,500 horse power) can reach depths of up to 125′ feet below grade for “Mix In Place” walls, such as soil Bentonite Walls, and soil cement Bentonite wall installations. The trencher 1210 can be a one-pass trencher that can mixed-in-place soil Bentonite and soil, cement Bentonite into a completely homogenized wall from top to bottom and from start to finish. These one-pass trenchers utilize a continuous vertical mixing that eliminates possibility for window or voids in the wall. One-pass barrier walls are evenly and consistently mixed throughout. These one-pass trenchers can mix a heavy high slump mix in place. This ability to mix a super heavy slump makes one-pass ideal for dam and levee repair. The mobile industrial mixing apparatus 100/200 can be used as a metered Bentonite delivery system.

These one-pass trenchers can use underground water injection nozzles, pre-mixed slurry injection ports, speed controls for both the mixing chain and track speeds, GPS mapping and laser guides to control depth. Engineers who use these one-pass trenchers prefer them to conventional excavator installation methods because of the completely homogenized soils from top to bottom, secure key into confining layer, no possibility for voids in the wall, precise laser installations, no messing mixing ponds, ability to work in tight sites, no open excavation and fast installation rates with a precise mapping of the alignment for future use. These one-pass trenchers can build trenches that are 125′+ deep, are 12″-48″ wide, and can build 200-500 linear feet per day.

In at least one embodiment, the industrial powdered bulk material 140 can be comprised of Bentonite which is an absorbent aluminium phyllosilicate clay consisting mostly of montmorillonite. It was named by Wilbur C. Knight in 1898 after the Cretaceous Benton Shale near Rock River, Wyo. The different types of Bentonite are each named after the respective dominant element, such as potassium (K), sodium (Na), calcium (Ca), and aluminium (Al). Bentonite usually forms from weathering of volcanic ash, most often in the presence of water. However, the term Bentonite, as well as a similar clay called tonstein, has been used to describe clay beds of uncertain origin. For industrial purposes, two main classes of Bentonite exist: sodium and calcium Bentonite. In stratigraphy and tephrochronology, completely devitrified (weathered volcanic glass) ash-fall beds are commonly referred to as K-Bentonites when the dominant clay species is illite. In addition to montmorillonite and illite, another common clay species that is sometimes dominant is kaolinite. Kaolinite-dominated clays are commonly referred to as tonsteins and are typically associated with coal.

The property of swelling on contact with water makes sodium Bentonite useful as a sealant, since it provides a self-sealing, low-permeability barrier. It is used to line the base of landfills to prevent migration of leachate, for quarantining metal pollutants of groundwater, and for the sealing of subsurface disposal systems for spent nuclear fuel.[10] Similar uses include making slurry walls, waterproofing of below-grade walls, and forming other impermeable barriers, e.g., to seal off the annulus of a water well, to plug old wells.

Bentonite can also be “sandwiched” between synthetic materials to create geosynthetic clay liners (GCLs) for the aforementioned purposes. This technique allows for more convenient transport and installation, and it greatly reduces the volume of bentonite required. It is also used to form a barrier around newly planted trees to constrain root growth so as to prevent damage to nearby pipes, footpaths and other infrastructure. Farmers use bentonite to seal retention ponds and line canals.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A mobile industrial mixing apparatus, comprising:
a frame;
a mixing chamber, coupled to the frame and including a housing, a top end, and a bottom end, the mixing chamber including a mixing mechanism disposed within the mixing chamber and to mix an industrial powdered bulk material with a liquid and further including a discharge opening to allow a mixture of the industrial powdered bulk material and the liquid to leave the mixing chamber;
a motor, coupled to the mixing mechanism, to drive the mixing mechanism;
a storage bin, coupled to the frame and disposed proximate to the bottom end of the mixing chamber, to receive the mixture of the industrial powdered bulk material and the liquid; and
a transport mechanism, coupled to the frame, to transport the mixing chamber and the storage bin.

2. The mobile industrial mixing apparatus according to claim 1, wherein the industrial powdered bulk material is Bentonite and the liquid is water.

3. The mobile industrial mixing apparatus according to claim 1, wherein the mixing mechanism is a first mixing mechanism and the mixing chamber is a first mixing chamber, the mobile industrial mixing apparatus further comprising a second mixing mechanism disposed within a second mixing chamber, and a divider to separate the first mixing chamber from the second mixing chamber.

4. The mobile industrial mixing apparatus according to claim 1, wherein the mixing mechanism includes a rotating shaft that extends from a front of the mixing chamber to a back of the mixing chamber.

5. The mobile industrial mixing apparatus according to claim 4, wherein the mixing mechanism further includes arms disposed along a length of the rotating shaft, with paddles disposed on ends of the arms, respectively.

6. The mobile industrial mixing apparatus according to claim 4, wherein the rotating shaft is a first rotating shaft, the mixing mechanism includes a second rotating shaft.

7. The mobile industrial mixing apparatus according to claim 1, wherein the motor is one of a hydraulic motor, an electric motor, pneumatic motor, gasoline motor, and propane motor.

8. The mobile industrial mixing apparatus according to claim 1, wherein the discharge opening is a first discharge opening, the storage bin being tapered to funnel the mixture of the industrial powdered bulk material and the liquid to a second discharge opening of the storage bin.

9. The mobile industrial mixing apparatus according to claim 1, wherein the transport mechanism includes one of wheels and a continuous track.

10. The mobile industrial mixing apparatus according to claim 1, further comprising a liquid storage tank, coupled to the frame, to store the liquid during transport of the industrial powdered bulk material, the transport mechanism further transporting the liquid storage tank.

11. The mobile industrial mixing apparatus according to claim 10, wherein the industrial mixing apparatus further includes a front side and a back side, the liquid storage tank being disposed on the front side of the mobile industrial mixing apparatus.

12. The mobile industrial mixing apparatus according to claim 10, further comprising a liquid pump, coupled to the frame, to pump the liquid from the liquid storage tank to the mixing chamber.

13. A system including an excavator to receive the mixture of the industrial powdered bulk material and the liquid produced by the mobile industrial mixing apparatus according to claim 1.

14. The system according to claim 13, wherein the excavator is a trencher.

15. The mobile industrial mixing apparatus according to claim 1, further including a hinged door coupled to the housing, the hinged door providing access to the mixing mechanism disposed within the mixing chamber.

16. The mobile industrial mixing apparatus according to claim 1, wherein the motor is coupled to the mixing mechanism via a belt.

17. The mobile industrial mixing apparatus according to claim 1, further comprising a mixture pump to pump the mixture of the industrial powdered bulk material and the liquid away from the mobile industrial mixing apparatus.

18. The mobile industrial mixing apparatus according to claim 1, further comprising a plurality of spray nozzles disposed within the mixing chamber to spray the liquid onto the industrial powdered bulk material during mixing of the industrial powdered bulk material and the liquid.
